(19) United States
(12) Patent Application Publication
(10) Pub. No.: US 2013/0054075 A1
(43) Pub. Date: Feb. 28, 2013

(54) Location Control System for Feature Placement

(71) Applicant: James Leonard Montgomery, Dubuque, IA (US)

(72) Inventor: James Leonard Montgomery, Dubuque, IA (US)

(73) Assignee: Deere and Company, Moline, IL (US)

(21) Appl. No.: 13/278,409

(22) Filed: Oct. 21, 2011

Related U.S. Application Data
(60) Provisional application No. 61/526,088, filed on Aug. 22, 2011.

(51) Int. Cl. G06F 17/00; G05D 1/00

(52) U.S. Cl. 701/25; 701/50; 701/1

(57) ABSTRACT

A system is provided for use in work machines that determines the location of the work machine is able to autonomously traverse between work locations. The system further provides the ability to identify corner post positions of a desired fence and have interstitial post locations automatically generated.

### FIELD

The instant disclosure relates generally to an earth excavating machine having a means of locating a position on the earth and/or beneath the surface of the earth. The present disclosure relates more specifically to an earth excavating machine having software onboard that monitors the geographic workspace of the machine to allow placement of features at desired locations.

### BACKGROUND & SUMMARY

Installing landscape features such as fencing, trees, shrubs, and flowers typically involves manual work and significant preparation of the worksite. Fence installation requires multiple posts placed at precise locations such that the overall fence provides a straight fencerow. Certain landscaping installations, such as golf courses or otherwise, place vegetation in specific locations to achieve an overall effect.

To achieve the required straight fencerows, fence installation further requires, determining fence corner locations, staking of a workspace, and drawing a string to establish a constant straight line, and determining non-corner post locations. The drawn string is left in place during fence construction to ensure a constant reference point and straight line. Accordingly, the drawn string presents an obstacle for users and machines. A machine drilling postholes or driving posts must approach each post location while not damaging or compromising the integrity of the straightness of the line. In use, fence building thus requires that any machine used to approach the drawn string from one side, place a post, reverse away from the drawn string, move down to the location of the next post, and approach the drawn string again.

According to a first embodiment, the present disclosure includes a work machine comprising a body; a computing system coupled to the body; an implement extending from the body, the implement configured to alter the ground of the workspace in which the work machine is located; a positioning system coupled to the body and in communication with the computing system, the positioning system providing data that is passed to the computing system such that the computing system can determine a location of the work machine and an orientation of the work machine; and software stored in memory electrically coupled to the computing system. The software including instructions that when interpreted by the computing system perform the steps of: receive an indication that the work machine is located at a first position; receive an indication of a second position where altering of the ground is desired; determine a path from the first position to the second position; issuing commands to cause movement of the machine such that the implement is positioned to alter the ground at the second position.

According to another embodiment of the present disclosure, a computer implemented system for monitoring of a work machine implement is provided. The system including: a first processing sequence that retrieves a map of a workspace; a second processing sequence that receives data from a global positioning system device coupled to the work machine; a third processing sequence that uses the data from the global positioning device to determine a location and orientation of the work machine; a fourth processing sequence that retrieves data regarding an implement attached to the work machine; a fifth processing sequence that determines the position of the implement; a sixth processing sequence that receives identification of a first desired post location; a seventh processing sequence that receives indication that the machine is being driven to a second desired post location; an eighth processing sequence that records ground surface profile information about a path taken from the first desired post location to the second desired post location; a ninth processing sequence that receives identification of the second desired post location; and a tenth processing sequence that automatically calculates a third desired post location, the calculation utilizing the first desired post location, the second desired post location, and the ground surface profile information.

According to another embodiment of the present disclosure, a computer implemented system for monitoring of a work machine implement is provided. The system including: a first processing sequence that retrieves a map of a workspace, the map having indications of at least one location of desired implement use; a second processing sequence that receives data from a global positioning system device coupled to the work machine; a third processing sequence that uses the data from the global positioning device to determine a location and orientation of the work machine; a fourth processing sequence that retrieves data regarding an implement attached to the work machine; a fifth processing sequence that determines the position of the implement; a sixth processing sequence that outputs data to a display to display the map, a representation of the work machine, and the at least one location of desired implement use; a sixth processing sequence that receives input selecting a first location of desired implement use of the at least one location of desired implement use; a seventh processing sequence that calculates a route from the position of the work machine to the first location of desired implement use; an eighth processing sequence that receives authorization to proceed to the first location of desired implement use; and a ninth processing sequence that outputs instructions to cause the machine to autonomously travel to the first location of desired implement use along the calculated route.

### BRIEF DESCRIPTION OF THE FIGURES

FIGS. 1 & 1a illustrate a skid steer machine equipped with global positioning capabilities;

FIG. 2 illustrates a display of the skid steer of FIG. 1 operating to effect fence installation;

FIG. 3 illustrates interaction of data structures running on an on-board computer of the skid steer of FIG. 1; and

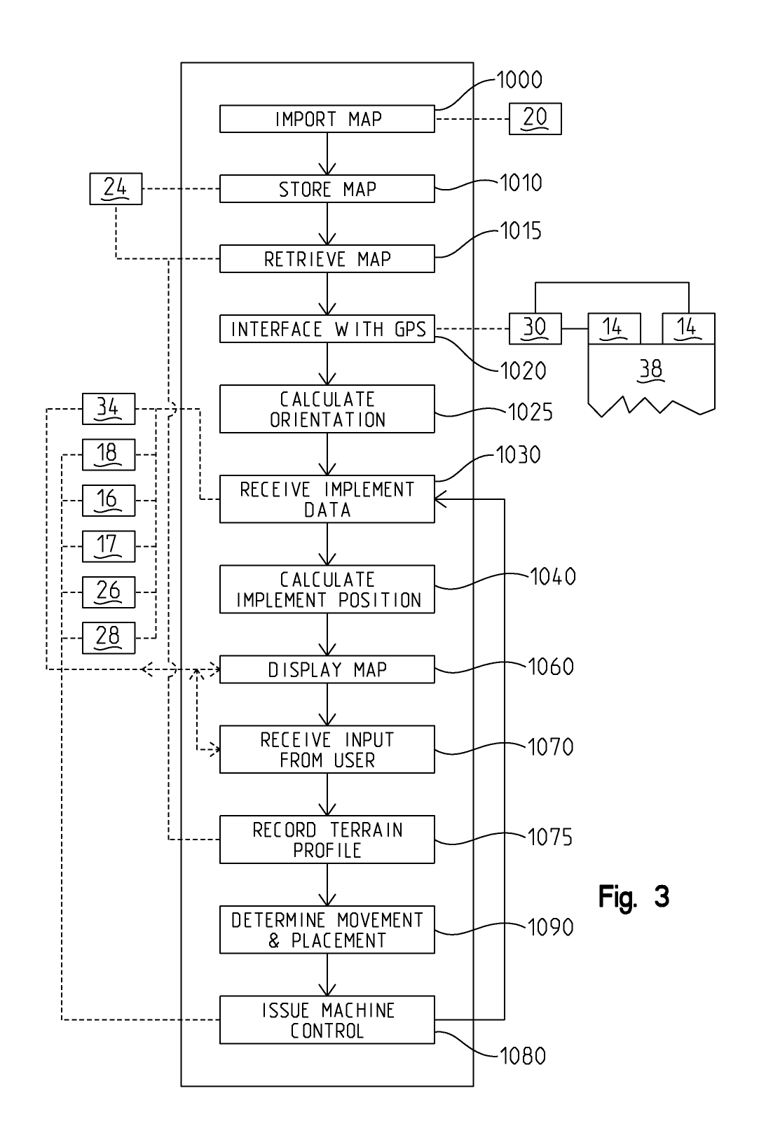

FIG. 4 illustrates display of FIG. 2 operating to aid in landscaping installation.

### DETAILED DESCRIPTION

The instant disclosure provides concepts finding utility with excavation machines 12. The disclosure discusses the use of a skid steer machine 12. However, the concepts are envisioned to be applied to tracked excavators, wheel-based excavators, tractor-based backhoes, and any other earth-moving type machines. The location of skid steer machine 12, or other machine for adjusting and moving surface and below surface earth, can be determined by a global positioning device (GPS) 30. GPS device 30 determines the location of its antenna 14 via transmissions from geosynchronous satellites. In that antenna 14 is located on machine 12, machine location may be determined via the satellite transmissions. The present disclosure contemplates excavation machine 12 having multiple GPS antennas 14 such that the direction that excavation machine 12 is facing can also be determined along with orientation of machine 12. Antennas 14 are illustratively positioned at top forward corners of cab 38 of machine 12. GPS device is further coupled to a device such as a cell phone, to provide a connection to a Real Time Kinematic GPS compensation system to provide increased accuracy.

Information regarding geographic workspaces can be obtained from workspace drawings or files that are constructed via measurements taken by hand, by GPS, or otherwise and then augmented via computer planning programs. Such augmentation includes information regarding desired placement of new fences, vegetation, and other features. Such drawings can be formatted according to any number of known formats, including popular CAD formats. Such geographic workspace information may also include information regarding the placement of sub-surface features such as utility lines. Such utility information can be considered during the process of placing features at the workspace. Such considerations are described more fully in the co-filed patent application titled “Buried Utility Data with Exclusion Zones” naming inventor James Leonard Montgomery. Whereas the cited application deals more with preventing intrusion into excluded subterranean areas, the present disclosure includes embodiments where data regarding subterranean features is considered when determining placement of new features.

Excavation machine 12 includes means for inputting workspace data, means for storing workspace data, means for displaying workspace data, and means for interacting with workspace data.

The means for inputting workspace data includes any communication device that allows for workspace data to be provided to an onboard computer of excavation machine 12. In the present example, a USB port 20 capable of receiving a flash drive having workspace data files thereon is provided as the means for inputting. Alternatively, the means for inputting is simply a keyboard that allows a user to type in workspace data. In yet another alternative, the means for inputting is a wireless link with the ability to download or otherwise receive data.

Excavation machine 12 then stores the data, such as in non-volatile memory 24, and provides for display of the data on display 34 of machine 12. Display 34 is provided as a simple flat screen display tablet. However, embodiments are envisioned where display 34 is a heads-up style display where images are projected or otherwise displayed on windows 36 of cab 38. The programming of the on-board computer includes software that can interpret the received and stored workspace data to provide a visual representation approximating a map of the workspace. Such a map includes the locations of various planned features indicated by the received workspace data. Options are provided that allow aerial/satellite maps, such as those obtained from Google Maps or otherwise, to be combined with the workspace data so that a user can more easily correlate map positions with real-world topology.

The means for interacting includes receiving and integrating information regarding the location of excavation machine 12 with the received and stored workspace data. In one embodiment such interacting takes the form of showing the location of excavation machine 12 on the map on display 34. Still further, the location of implements, such as a post driver and auger are shown on display 34. As will be described below, such interacting also includes indicating when placement of machine 12 and the implements matches up with the desired placement of planned features.

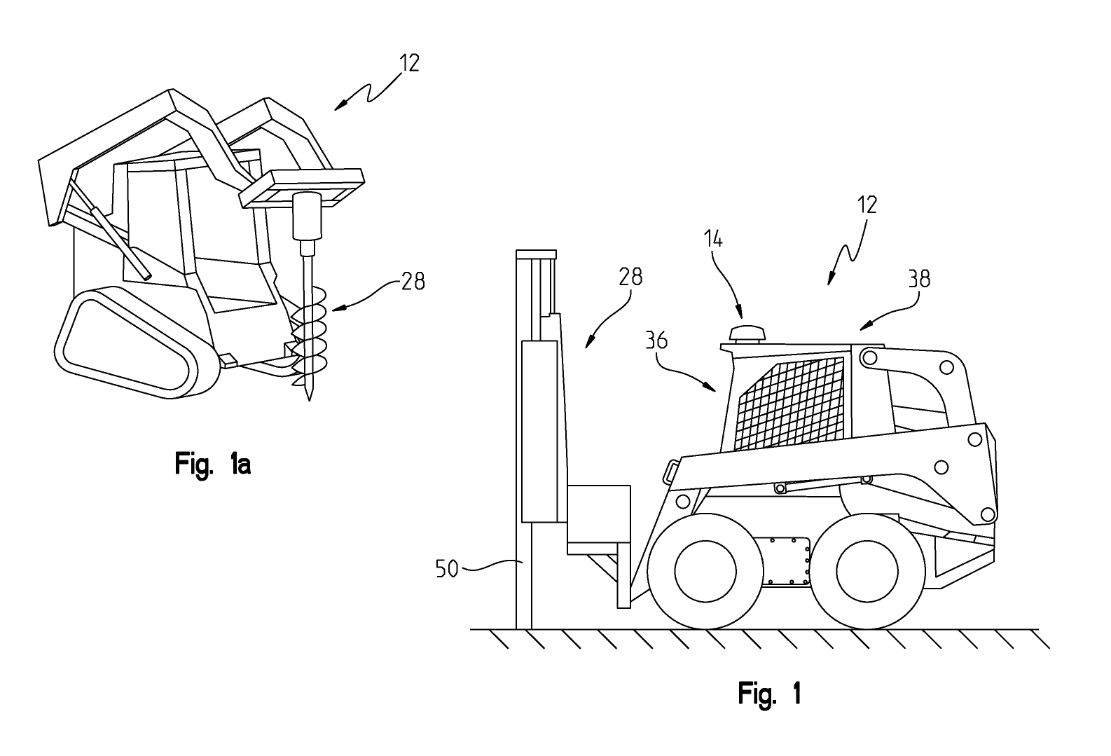

As previously noted the location of GPS antenna 14 on machine 12 is known to the programmers of the software onboard excavation machine 12 or is input by a user. Similarly, the relative offset of antenna 14 to other parts of machine 12 is also known to the software, either by being preset or being input by a user. An offset is the distance, direction, orientation, and depth (or height) of a geographic feature or machine part determined with respect to the location of the GPS antenna or other location on machine 12. When the offset is combined with a GPS determined location of machine 12, the location of the feature or machine part can be identified in three coordinates. Whenever an auger (FIG. 1a) or post driver (FIG. 1) is attached to machine 12, the offset of the point at which the implement 28 interacts with ground is known. Thus, such implements 28 are also then displayed on display 34 in real-time.

It should also be appreciated that excavation machine 12 can take on different implements 28, or other implements, each having different sizes and shapes, thus producing different offsets associated therewith. Accordingly, the identity of implement 28 is also provided to the on-board computer. While the raw measurement data of implement 28 can be provided to the computer, the computer may also have pre-stored configuration files that provide the offset data for various common implements 28. Different implements 28 can be identified to the computer via user entry, or through an automated means, such as an RFID reader located near the point of attachment (and in communication with the computer) and a RFID tag located on implement 28.

The working environment of machine 12 may include uneven terrain. The body of machine 12 may be oriented such that the pitch and roll of the excavator deviates from horizontal and vertical. Pitch and roll measurement are determined by noting the difference in location of antennas 14 mounted on the machine cab 38 (or elsewhere on the frame of machine 12) that provide data to the computer respective to pitch and roll of the machine 12. However, various inclinometers and other sensors can also provide this information. Pitch and roll acting on the tracks or wheels of machine 12 are translated to the implement 28. Skid steer machines 12 can provide approximately +\−30° of adjustment travel in pitch and roll.

All of the above serves to provide information about the location of excavation machine 12, including but not limited to implement 28. This information is combined with the mapping information in the computer to provide a real-time interactive representation of the workspace in which excavation machine 12 is located. Such mapping information informs a user regarding the various features of the workspace, including the position of desired features, and the relative position of the parts of excavation machine 12 to the workspace features and desired features. Such mapping information provides a visual contextual rendering of the relative spacing of machine 12 in the workspace and of features of the workspace and desired features of the workspace.

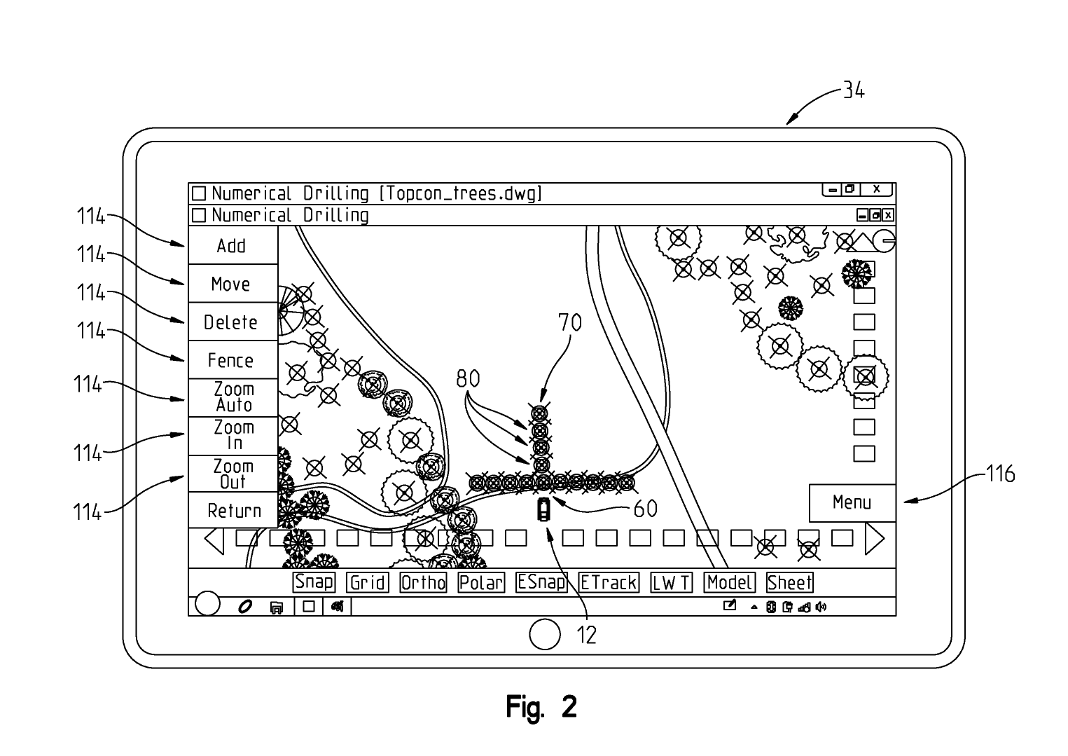

FIG. 2 shows display 34 in a fence installation mode. Machine 12 is depicted on the map to show the current location and orientation thereof. The location of posts 50 for the desired fence are either pre-located and provided to the computer, or the positions can be calculated. For embodiments where the positions are pre-located, machine 12 is maneuvered such that post driver 28 is appropriately located over a first post location, as determined by viewing display 34. A post is then driven at that location. Such a process is repeated for each successive fence post location.

For embodiments where the post locations are not pre-located, machine 12 includes software that determines appropriate placement thereof. To use such software, post driver 28 is placed at a first corner location 60. The user taps a button on display 34 to indicate that fence corner 60 is desired at the present location. The user further taps a button on display 34 to enable terrain recording. The machine 12 then drives along the approximate path of the fence to a second corner position 70. While driving along the approximate path, in that terrain recording has been enabled, the onboard computer is provided data regarding the surface profile (changes in elevation, pitch, and roll). Once post driver 28 is at the second corner location 70, the user taps a button on display 34 to indicate that fence corner 70 is desired at the present location. Once both corner locations 60, 70 are known and the surface profile along the fence path is known, the computer automatically calculates the positioning of interstitial posts 80. Interstitial posts 80 are also then displayed on display 34. The calculation for placement of interstitial posts 80 takes into account desired post spacing, desired number of posts, surface profile data, and known underground features (utility lines). Similarly, positions 60 and 70 are checked to make sure that they are suitable locations for posts.

Once the post locations are mapped out, placement of posts can begin. It should be appreciated, that having driven from location 60 to location 70, the rear of machine 12 is facing position 60. First, a post is loaded and driven into the ground at location 70. Once properly driven, the post is released. As previously noted, the surface profile is recorded as machine 12 traverses the desired fencerow location. When machine 12 arrives at a location to place a post, machine 12 determines pitch and roll, via dedicated sensors, or via GPS 30. Machine 12 then compensates to position post driver 28 to ensure that the post is driven vertically.

Once a post is vertically driven and released at location 70, machine 12 can simply back up until it reaches the next post location. Thus, machine 12 can progress from one post location to the next by just going in reverse, as opposed to having to move in multiple directions. The process of compensating to ensure verticality and actually driving the post is then repeated. This process is repeated until a post is placed at location 60.

While the description to this point has contemplated machine 12 having a driver located in cab 38 to move it between post locations, it should be appreciated that embodiments are envisioned where machine 12 operates via remote control. Such embodiments would include machine 12 having a remote control receiver. One such receiver is a Cattron RF Pendant RF/CAN bridge. The receiver provides two way communications between the remote and the receiver. The receiver has the ability to receive 12 distinct inputs from the remote and includes two state switches. While a particular receiver/remote has been disclosed, any suitable receiver/remote can be used.

In such embodiments, a user would likely drive machine 12 (from within cab 38 or by remote control) to locations 60 and 70. The user would then get out of machine 12 if driving from within cab 38 and supply post driver 28 with a post at location 60. The user would then press a button on a remote control to initiate any adjustments to achieve verticality of post driver 28 followed by a button to instruct driving of the post. Alternatively, a command to drive the post automatically levels post driver 28.

The user then presses a button to instruct machine 12 to proceed to the next post location. Once there, user 12 again supplies a post into post driver 12 and again initiates the leveling and post driving sequences. Accordingly, posts are driven in a straight line without requiring staking, drawing of strings, or the encumbrances on movement and time associated therewith. It should be appreciated that the above process eliminates steps relative to traditional fence installation. The above process further requires less people in that a single person can perform all steps. The ability to drive directly between post locations provides fuel savings. The semi-automated system further provides time savings. Once posts are placed, the connecting portions of the fence can be added (wire, wood, or otherwise). The calculated placement of the posts thereby results in a straight fencerow without the need for a human to draw a string line, or physically measure and mark the ground.

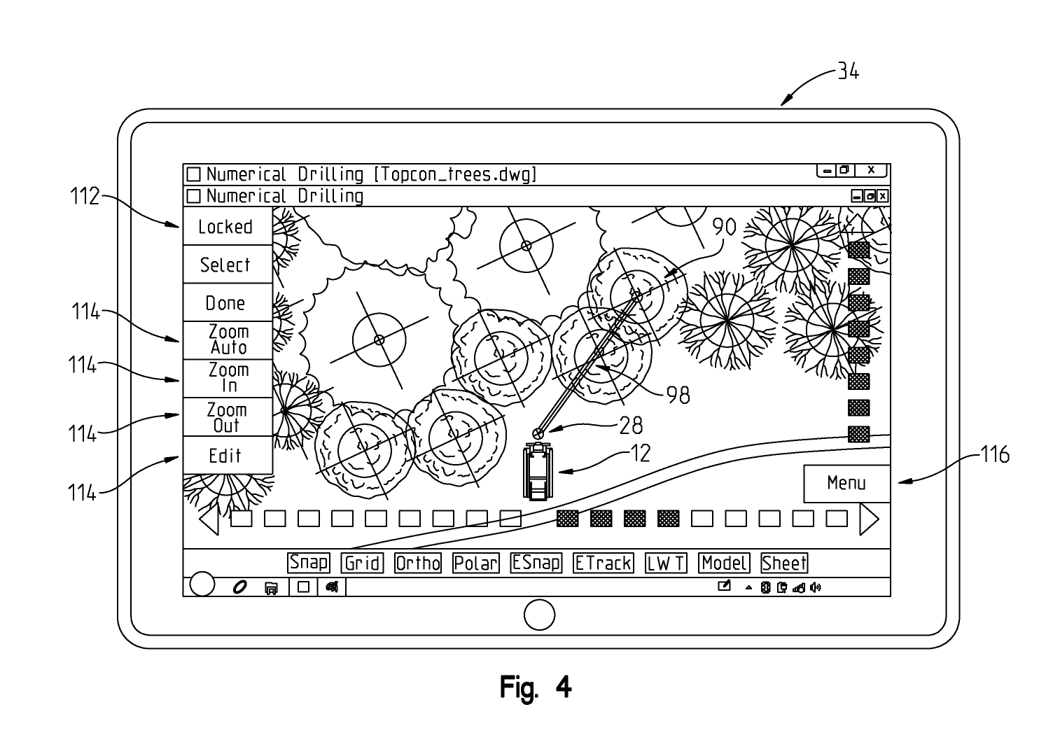

FIG. 4 shows display 34 in a tree planting mode. In addition to the above described embodiment where dig locations are determined in the field and “on the fly,” embodiments also exist where the dig locations are determined ahead of time. While use of machine 12 is described below for use of pre-determined dig sites for planting, such an embodiment is also usable with fence placement where the fencepost locations are pre-determined and provided via a map file or otherwise.

Machine 12 is depicted on the map to show the current location and orientation thereof. The locations of desired trees 90 are either pre-located and provided to the computer, or can be placed via display 34. In tree planting mode, implement 28 of machine 12 is an auger. In operation, the user is able to designate the desired tree to plant by tapping on its location. The computer then calculates the necessary movements to cause machine 12 to move auger 28 to a proper position. The movements are displayed on display 34 as a highway 98. The user can then initiate movement to position 95. Such movement can be user controlled, or can be automatic. If the movement is automatic, machine 12 is driven along highway 98 to position 95. In the provided embodiment, a user interacts with a joystick to control speed of movement of machine 12, but direction is controlled by computer. In embodiments where the movement is totally user controlled, directions are provided on display 34 instructing the user via steering cues. Once arriving, auger 28 is invoked, either via a subsequent user action, or automatically. Once the hole is dug, a user can select a next hole. Additionally, embodiments are envisioned where the next closest desired hole is automatically chosen. Also, work machine 12 can detect and record the fact that auger 28 was used at a particular location. The display of the location can also be changed to identify that auger 28 has been used at the location. Using this data, the selection of the next closest hole location is limited to hole locations that have not already been dug.

Display 34 is illustratively a touch screen. Accordingly, the screen provides a plurality of commands/input/informational buttons. Such buttons include informational buttons 112 that provide information regarding settings (see FIG. 4, button 112 indicating that the system is locked on to a hole position). Examples of informational buttons 112 are ones that indicate whether an entire worksite is being shown or a workspace is being shown (where a workspace is smaller and more local to machine 12 relative to “worksite”). Command buttons 114 include “Zoom In,” “Zoom Out,” “Zoom Auto,” “Edit,” “Add,” “Move,” “Delete,” and “Fence.” Zoom buttons allow a worksite view to be zoomed in or out as desired. Command buttons 114 also include various functions relating to loading, saving, importing, and exporting files which would be accessed by selecting the “Menu” button 116. “Menu” button 116 also provides access to various settings. One such setting allows providing an indication of the length of post being driven. “Add” button allows adding of a post location or tree location. “Move” allows proposed features to be moved. “Delete” allows proposed features to be deleted. “Fence” button indicates that a fence, including interstitial posts 80 should be calculated and displayed.

Accordingly, it should be appreciated that the software running on the computer onboard machine 12 includes a plurality of data structures. Such data structures include data structures for importing map data 1000, for storing map data 1010, for retrieving map data 1015, for interfacing with a GPS device 1020, for calculating machine orientation 1025, for receiving implement relative positioning data 1030, for calculating implement absolute positioning data 1040, for displaying map and positioning data 1060, for receiving user input 1070, and for issuing machine control signals 1080.

The data structure for importing map data 1000 interfaces with USB port 20 (or other similar interface) to obtain map data. This data is passed to the data structure for storing map data 1010. Structure 1010 interfaces with memory 24 to store the map data. The data structure for retrieving map data 1015 interfaces with memory 24 to retrieve previously stored map data. The data structure for interfacing with a GPS device 1020 communicates with GPS device 30 (which is in communication with the plurality of antennas 14) to obtain GPS coordinates for antennas 14. The data structure for calculating machine orientation 1025 takes the obtained GPS coordinates and determines the position of machine 12 as well as compares the GPS readings from each antenna 14 to determine the orientation of machine 12. The data structure for receiving implement relative positioning data 1030 interfaces with display 34 for any user input data regarding the particular implement being used (or alternatively with another indicator of the implement, such as an RFID reader). This relative positioning data is then passed to structure 1040. The structure for calculating implement absolute positioning data 1040 takes the relative positioning data from structure 1030 and combines it with the GPS positioning and orientation data from structure 1025 to determine the physical space inhabited by implement 28. Data regarding the position of machine 12 and implement 28 is passed to structure 1060.

The structure for displaying map and positioning data 1060 takes the passed data and presents an integrated data set to display 34. Structure for receiving user input 1070 allows a user to interact with display 34 to alter the displayed map and to otherwise initiate other data structures (such as those that allow for creation of new map features, to start terrain recording (structure 1075), to identify corner fencepost locations, to select a tree planting location). While structure 1070 is described as interacting with display 34, it should be appreciated that user input also comes from a remote control, if used. Structure 1070 also receives input regarding desired movement of machine 12 (including movement of implement 28). Input regarding movement commands is passed to structure 1080.

Structure 1075 records the terrain surface profile. When used, the data gathered form structure 1075 is passed to structure 1090. Like structure 1075, the structure for determining vehicle movement and feature placement 1090 is often specific to the particular implementation of vehicle 12. For the fencerow implementation, structure 1090 takes data from structure 1075 and then calculates the locations of the fence posts to be placed. This data is then passed to structure 1080. For hole drilling/tree placement implementations, hole choice is relayed to structure 1075 such that a “highway” is created that defines the travel path of machine 12 to the desired location. Again, such data is then passed to structure 1080.

Structure for issuing machine control signals 1080 takes the passed movement commands and uses them to initiate vehicle movement.

When movement commands are passed along from structure 1080 such movement impacts the location of GPS antenna 14 and the position of implement 28. The calculations to determine the implement's absolute position are repeated (structures 1030, 1040). As should be understood, many of the structures are implemented in an iterative fashion such that the map on display 34 is constantly being redrawn and the position of machine 12 and its parts is constantly being re-assessed. In this way, a real-time representation of machine 12 in the workspace is presented on display 34.

While this application discusses use of satellite based GPS, the concepts could also be used along with local positioning stations and other known similar means. Similarly, the utility and benefits described herein as well as modifications and adaptations by those skilled in the art may adapt the invention to specific uses without departing from the spirit and scope of the invention as claimed.

1. A work machine comprising:
a body;
a computing system coupled to the body;
an implement extending from the body, the implement configured to alter the ground of the workspace in which the work machine is located;
a positioning system coupled to the body and in communication with the computing system, the positioning system providing data that is passed to the computing system such that the computing system can determine a location of the work machine and an orientation of the work machine; and
software stored in memory electrically coupled to the computing system, the software including instructions that when interpreted by the computing system perform the steps of:
receiving an indication that the work machine is located at a first position;
receiving an indication of a second position where altering of the ground is desired;
determining a path from the first position to the second position; and
issuing commands to cause movement of the machine such that the implement is positioned to alter the ground at the second position.

2. The work machine according to claim 1, wherein the software further includes instructions that cause the computing system to perform the step of recording a surface profile of the path between the first position and the second position.

3. The work machine according to claim 1, wherein the desired altering of the ground includes digging with an auger and the second position is a location where auger use is desired.

4. The work machine of claim 1, further including a display viewable by a user of the work machine, the display showing a map of a workspace and relative positioning of the work machine in the workspace.

5. The work machine according to claim 4, wherein the display includes a first representation of a first desired feature at the second position, the software receiving an indication that the first representation has been selected, the step of determining a path from the first position to the second position occurring automatically upon receipt of the indication that the first representation has been selected.

6. The work machine according to claim 1, wherein the desired altering of the ground includes the placing of a fence post and the software further causes the computing system to:
receive an indication that the first position is a first fence post location,
receive an indication that the second position is a second fence post location,
receive information regarding a surface profile of a path between the first post location and the second post location,
calculate a position of a third post based upon the first post location, the second post location, and the surface profile.

7. The work machine according to claim 6, wherein the surface profile is recorded as the machine drives from the second position to the first position.

8. The work machine of claim 6, wherein the software further causes the computing system to:
issue instructions for the work machine to autonomously maneuver from the second position to the third post position such that the implement is positioned to place a fence post at the third post position.

9. The work machine of claim 6, wherein the third position is calculated such that posts placed at the first, second, and third position form a straight line.

10. The works machine of claim 9, wherein the instructions issued by the computing system instruct the work machine to travel along the straight line when moving between the second and third location.

11. The work machine according to claim 6, wherein the software further causes the computing system to:
receive input indicating a desired distance between adjacent posts, wherein the position of the third post is calculated at least partially based upon the desired distance between adjacent posts.

12. A computer implemented system for monitoring of a work machine implement, including:
a first processing sequence that retrieves a map of a workspace;
a second processing sequence that receives data from a global positioning system device coupled to the work machine;
a third processing sequence that uses the data from the global positioning device to determine a location and orientation of the work machine;
a fourth processing sequence that retrieves data regarding an implement attached to the work machine;
a fifth processing sequence that determines the position of the implement;
a sixth processing sequence that receives identification of a first desired post location;
a seventh processing sequence that receives indication that the machine is being driven to a second desired post location;
an eighth processing sequence that records ground surface profile information about a path taken from the first desired post location to the second desired post location;
a ninth processing sequence that receives identification of the second desired post location; and
a tenth processing sequence that automatically calculates a third desired post location, the calculation utilizing the first desired post location, the second desired post location, and the ground surface profile information.

13. The system of claim 12, further including an eleventh processing sequence that displays the map data, the first desired post location, the second desired post location, and the third desired post location on a display.

14. The system of claim 12, further including a twelfth processing sequence that receives an indication that a post has been placed at the second desired post location.

15. The system of claim 14, further including a thirteenth processing sequence that produces instructions to cause the machine to autonomously proceed from the second desired post location to the third desired post location.

16. A computer implemented system for monitoring of a work machine implement, including:
a first processing sequence that retrieves a map of a workspace, the map having indications of at least one location of desired implement use;
a second processing sequence that receives data from a global positioning system device coupled to the work machine;
a third processing sequence that uses the data from the global positioning device to determine a location and orientation of the work machine;
a fourth processing sequence that retrieves data regarding an implement attached to the work machine;
a fifth processing sequence that determines the position of the implement;
a sixth processing sequence that outputs data to a display to display the map, a representation of the work machine, and the at least one location of desired implement use;
a sixth processing sequence that receives input selecting a first location of desired implement use of the at least one location of desired implement use;
a seventh processing sequence that calculates a route from the position of the work machine to the first location of desired implement use;
an eighth processing sequence that receives authorization to proceed to the first location of desired implement use; and
a ninth processing sequence that outputs instructions to cause the machine to autonomously travel to the first location of desired implement use along the calculated route.

17. The system of claim 16, wherein the input selecting the first location of desired implement use comes from the display.

18. The system of claim 17, further including a tenth processing sequence that receives an indication that the implement was used at the first location.

19. The system of claim 18, further including an eleventh processing sequence that automatically picks a second location of desired implement use of the at least one location of desired implement use.

20. The system of claim 19, wherein the eleventh processing sequence picks the second location by considering the distances to other locations of desired implement use, and considering which locations of desired implement use have already undergone implement usage.
